(19) United States
(12) Patent Application Publication
(10) Pub. No.: US 2013/0214734 A1
(43) Pub. Date: Aug. 22, 2013

(54) APPARATUS AND METHOD FOR WIRELESS CHARGING

(71) Applicant: Samsung Electronics Co., Ltd., (US)

(72) Inventors: Noh-Gyoung Kang, Seoul (KR); Tae-Han Bae, Seoul (KR); Jae-Seung Son, Gyeonggi-do (KR); Eun-Tae Won, Seoul (KR); Hee-Won Jung, Gyeonggi-do (KR)

(73) Assignee: Samsung Electronics Co., Ltd., Gyeonggi-do (KR)

(21) Appl. No.: 13/772,824

(22) Filed: Feb. 21, 2013

(30) Foreign Application Priority Data
Feb. 21, 2012 (KR) 10-2012-0017501

(51) Int. Cl. H02J 7/00; H02J 7/02

(52) U.S. Cl. CPC H02J 7/0013; H02J 7/025
USPC 320/108; 320/137

(57) ABSTRACT

An apparatus and a method for wireless charging are disclosed. The method includes transmitting a wireless power supply apparatus search signal, receiving a wireless power supply apparatus search response signal and recognizing multiple apparatuses for wirelessly supplying power, sending a request for wirelessly supplying power to a first apparatus, sending a request for cooperative charging to a second apparatus, and receiving first and second power from the first and the second apparatuses, respectively, and performing wireless charging according to reception of a cooperative charging permission signal from the second apparatus for wirelessly supplying power.

### PRIORITY

This application claims priority under 35 U.S.C. §119(a) to Korean Patent Application Serial No. 10-2012-0017501, which was filed in the Korean Intellectual Property Office on Feb. 21, 2012, the content of which is incorporated herein by reference.

### BACKGROUND OF THE INVENTION

1. Field of the Invention

The present invention relates generally to an apparatus and a method for wireless charging, and more particularly to an apparatus and a method for wireless charging, which use an apparatus for wirelessly receiving power and performing wireless charging and an apparatus for wirelessly supplying power.

2. Description of the Related Art

Due to the proliferation of portable electronic products along with the progress of Information Technology (IT), various technologies for providing power to portable electronic products have been developed. Particularly, conventional technology involves receiving power from a power line. More recently, technology has been developed for wireless power transmission.

The wireless power transmission technology enables the wireless supply of electric energy (i.e. electric power) any time and place without a power line. This wireless power transmission technology provides wireless charging for an electronic device and wireless power supply and charging for an electric car, for example, and may be capable of replacing the existing wired scheme for power supply and charging.

For example, wireless charging methods are largely classified into electromagnetic induction using a coil, resonance, and Radio Frequency (RF)/microwave radiation for converting electric energy to a microwave and radiating the microwave. Until now, the wireless charging method using electromagnetic induction has been the most widely used.

The wireless charging method using electromagnetic induction is for transmitting power between a primary coil and a secondary coil. An induction current is generated when a magnet moves through a coil. A transmission side (i.e. an apparatus for wirelessly supplying power) generates a magnetic field by using the induction current, and a reception side (i.e. an apparatus for wirelessly receiving power) generates electric energy by inducing a current according to a change in a magnetic field. The apparatus for wirelessly receiving power performs wireless charging by charging the electric energy as generated above in a battery.

The conventional wireless charging technologies have been used in electric shavers and toothbrushes, for example. Recently, a more advanced resonance method has been developed, and the wireless charging technology using electromagnetic induction is variously introduced to various typestypes of devices, such as mobile phones and TVs.

Meanwhile, in the conventional wireless charging method, the apparatus for wirelessly receiving power receives power only from the closest first apparatus for wirelessly supplying power. Accordingly, when the first apparatus for wirelessly supplying power fails to supply this power, a problem occurs in that the apparatus for wirelessly receiving power fails to receive power from other apparatuses for wirelessly supplying power, although these other apparatuses are in the vicinity of the apparatus for wirelessly receiving power.

Also, conventionally, when an amount of power required for charging of the apparatus for wirelessly receiving power is larger than an amount of power capable of being supplied by the closest first apparatus for wirelessly supplying power, although there exists power capable of being supplied by the first apparatus for wirelessly supplying power, the first apparatus does not supply power. Accordingly, a problem occurs in that the power capable of being supplied by the first apparatus cannot be used.

### SUMMARY OF THE INVENTION

Accordingly, an aspect of the present invention is to solve the above-mentioned problems, and to provide an apparatus and a method for wireless charging, which can cooperatively receive power from multiple apparatuses for wirelessly supplying power and can perform wireless charging, when an apparatus for wirelessly receiving power fails to receive sufficient power from any one of the multiple apparatuses for wirelessly supplying power, which are in the vicinity of the apparatus for wirelessly receiving power.

Another aspect of the present invention is to provide an apparatus and a method for wireless charging, by which an apparatus for wirelessly receiving power receives power from a first apparatus for wirelessly supplying power and can receive remaining power other than the already received power, from another second apparatus for wirelessly supplying power before the apparatus for wirelessly receiving power can perform wireless charging, even when an amount of power capable of being supplied by the first apparatus for wirelessly supplying power among multiple apparatuses for wirelessly supplying power, which are in the vicinity of the apparatus for wirelessly receiving power, is less than an amount of power required for charging of the apparatus for wirelessly receiving power.

In accordance with an aspect of the present invention, a method for wireless charging in an apparatus that wirelessly receives power is provided. The method includes transmitting, by the apparatus, a wireless power supply apparatus search signal; receiving a wireless power supply apparatus search response signal; recognizing multiple apparatuses for wirelessly supplying power, based on the wireless power supply apparatus search response signal; sending a request for wirelessly supplying power, to a first apparatus for wirelessly supplying power among the multiple apparatuses; receiving a cooperative charging enable signal from the first apparatus; sending a request for cooperative charging to a second apparatus for wirelessly supplying power, based on the cooperative charging enable signal from the first apparatus; receiving a cooperative charging permission signal from the second apparatus; receiving first power and second power from the first apparatus and the second apparatus, respectively; and performing wireless charging using the first power and the second power.

In accordance with another aspect of the present invention, an apparatus for wirelessly receiving power is provided. The apparatus includes a communication unit for communicating with at least one apparatus that wirelessly supplies power; a power receiver for wirelessly receiving power from multiple apparatuses that wirelessly supply power; and a controller for controlling the communication unit to transmit a wireless power supply apparatus search signal, recognizing the multiple apparatuses that wirelessly supply power based on a wireless power supply apparatus search response signal received through the communication unit, sending a request for wirelessly supplying power to a first apparatus that wirelessly supplies power among the multiple apparatuses, controlling the communication unit to transmit a cooperative charging request signal to a second apparatus that wirelessly supplies power based on a cooperative charging enable signal received from the first apparatus, and controlling the power receiver to receive first power and second power from the first apparatus and the second apparatus, respectively, when a cooperative charging permission signal is received from the second apparatus.

In accordance with another aspect of the present invention, a method for wireless charging by an apparatus that wirelessly supplies power is provided. The method includes receiving, by the apparatus, a wireless power supply apparatus search signal from an charging apparatus that wirelessly receives power; transmitting a wireless power supply apparatus search response signal to the charging apparatus; receiving a power supply request signal including an amount of power required by the charging apparatus; determining whether an amount of power capable of being supplied by the apparatus is at least equal to the amount of power required by the charging apparatus; and transmitting a cooperative charging enable signal, when the amount of power capable of being supplied is not at least equal to the amount of power required by the charging apparatus.

In accordance with another aspect of the present invention, a method for wireless charging by an apparatus that wirelessly supplies power is provided. The method includes receiving a cooperative charging request signal including an amount of power requiring cooperation from a charging apparatus that wirelessly receives power; determining whether an amount of power capable of being supplied by that apparatus is at least equal to the amount of power requiring the cooperation; and transmitting a cooperative charging permission signal to the charging apparatus, when the amount of power capable of being supplied is at least equal to the amount of power requiring the cooperation.

In accordance with another aspect of the present invention, an apparatus for wirelessly supplying power to a charging apparatus that wirelessly receives power is provided. The apparatus includes a communication unit for communicating with the charging apparatus; a power supply unit for wirelessly transmitting power; and a controller for receiving a wireless power supply apparatus search signal from the charging apparatus through the communication unit, controlling the communication unit to transmit a wireless power supply apparatus search response signal, determining whether an amount of power capable of being supplied by the apparatus is at least equal to an amount of power required by the charging apparatus in response to a power supply request signal received from the charging apparatus, and transmitting a cooperative charging enable signal through the communication unit, when the amount of power capable of being supplied by the apparatus is not at least equal to the amount of power required by the charging apparatus.

### BRIEF DESCRIPTION OF THE DRAWINGS

The above and other features, aspects, and advantages of the present invention will be more apparent from the following detailed description taken in conjunction with the accompanying drawings, in which:

FIG. 1 illustrates an apparatus for wirelessly receiving power and multiple apparatuses for wirelessly supplying power according to an embodiment of the present invention;

FIG. 2 illustrates a method for performing wireless charging cooperatively between an apparatus for wirelessly receiving power and multiple apparatuses for wirelessly supplying power according to an embodiment of the present invention;

FIG. 3 illustrates the configuration of an apparatus for wirelessly receiving power and the configuration of an apparatus for wirelessly supplying power according to an embodiment of the present invention;

FIG. 4 illustrates the operation of an apparatus for wirelessly receiving power according to an embodiment of the present invention; and

FIG. 5 illustrates the operation of an apparatus for wirelessly supplying power according to an embodiment of the present invention.

### DETAILED DESCRIPTION OF EMBODIMENTS OF THE PRESENT INVENTION

Hereinafter, embodiments of the present invention will be described with reference to the accompanying drawings. The following description includes specific details, and the specific details are only provided in order to help a more comprehensive understanding of the present invention. Therefore, it will be apparent to a person having in ordinary knowledge in the technical field that changes and modifications can be made in the specific details without departing from the scope of the present invention. In addition, descriptions of well-known functions and constructions are omitted for the sake of clarity and conciseness.

According to the present invention, an apparatus for wireless charging can be applied to an apparatus for wirelessly receiving power and an apparatus for wirelessly supplying power. The apparatus for wireless charging according to the present invention can be applied to such functions as wireless charging for a portable electronic device, wireless power supply and wireless charging for an electric car, and wireless power supply to a remote place, power supply to a ubiquitous wireless sensor, and can be applied to any apparatus for wirelessly supplying and receiving power.

When an apparatus for wirelessly receiving power according to the present invention fails to receive sufficient power from any one of multiple apparatuses for wirelessly supplying power around the apparatus for wirelessly receiving power, it can receive power from each of the multiple apparatuses for wirelessly supplying power, and can perform cooperative wireless charging.

More specifically, when an amount of power capable of being supplied by, for example, the closest first apparatus for wirelessly supplying power, which has the highest possibility of supplying power to an apparatus for wirelessly receiving power among multiple apparatuses for wirelessly supplying power which are in the vicinity of the apparatus for wirelessly receiving power, is less than an amount of power required for charging of the apparatus for wirelessly receiving power, the apparatus for wirelessly receiving power according to the present invention receives power that the apparatus for wirelessly receiving power receives from the first apparatus for wirelessly supplying power, receives the remaining required power from a second (i.e., another) apparatus for wirelessly supplying power, and performs cooperative wireless charging. The cooperative wireless charging implies that one apparatus for wirelessly receiving power receives power from multiple apparatuses for wirelessly supplying power and performs charging.

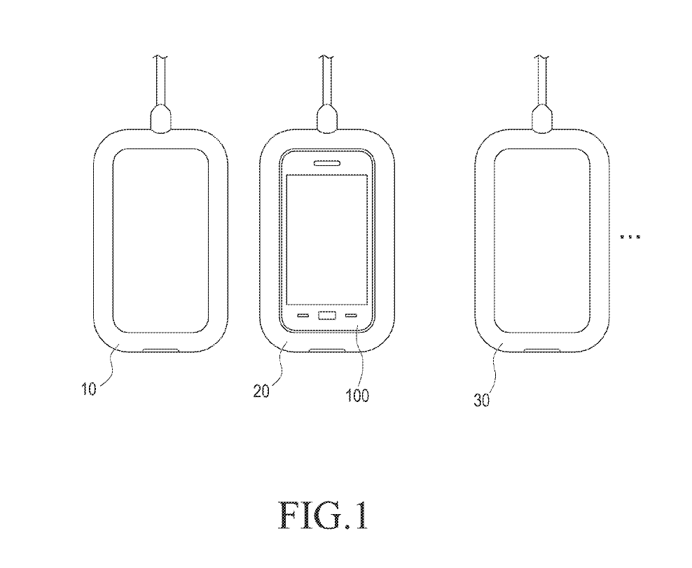

FIG. 1 illustrates an apparatus for wirelessly receiving power and multiple apparatuses for wirelessly supplying power according to an embodiment of the present invention. Referring to FIG. 1, reference numeral 100 denotes an apparatus for wirelessly receiving power, and reference numerals 10, 20 and 30 denote multiple apparatuses for wirelessly supplying power. The apparatus 100 for wirelessly receiving power may be a portable electronic device, such as a mobile terminal, and the apparatus 10 for wirelessly supplying power may be an apparatus such as a charging pad. The present invention will describe an example in which the apparatuses 10, 20 and 30 for wirelessly supplying power and the apparatus 100 for wirelessly receiving power correspond to charging pads and a mobile terminal, respectively.

In FIG. 1, the first to third charging pads 10, 20 and 30 are close to the mobile terminal 100, and a charging pad which is the closest to the mobile terminal 100 (i.e. which has the highest possibility of supplying power to the mobile terminal 100) is the first charging pad 10. The mobile terminal 100 transmits power supplying device search signals and recognizes the first to third charging pads 10, 20 and 30 close to the mobile terminal 100 by receiving power supplying device search response signals from the first to third charging pads 10, 20 and 30. The mobile terminal 100 determines a respective distance between the mobile terminal and the first to third charging pads 10, 20 and 30 according to strengths of the power supplying device search response signals.

In this case, when a maximum amount of power capable of being supplied by the first charging pad 10 is less than an amount of power required for charging of the mobile terminal 100, the mobile terminal 100 receives an amount of power that the mobile terminal 100 can receive from the first charging pad 10, receives a remaining required amount of power from the second charging pad 20 which is close to the mobile terminal 100 after the first charging pad 10 (i.e. which has a higher possibility of supplying power to the mobile terminal 100 after the first charging pad 10), and then performs cooperative wireless charging.

When the mobile terminal 100 fails to receive power from the second charging pad 20, the mobile terminal 100 may first receive power from the third charging pad 30 which is close to the mobile terminal 100 after the second charging pad 20 (i.e. which has a higher possibility of supplying power to the mobile terminal 100 after the second charging pad 20), and may then perform cooperative wireless charging. At this time, the mobile terminal 100 may receive a cooperative charging enable signal from the first charging pad 10 and a cooperative charging permission signal from the second charging pad 20 or the third charging pad 30, and may determine whether it can perform cooperative wireless charging.

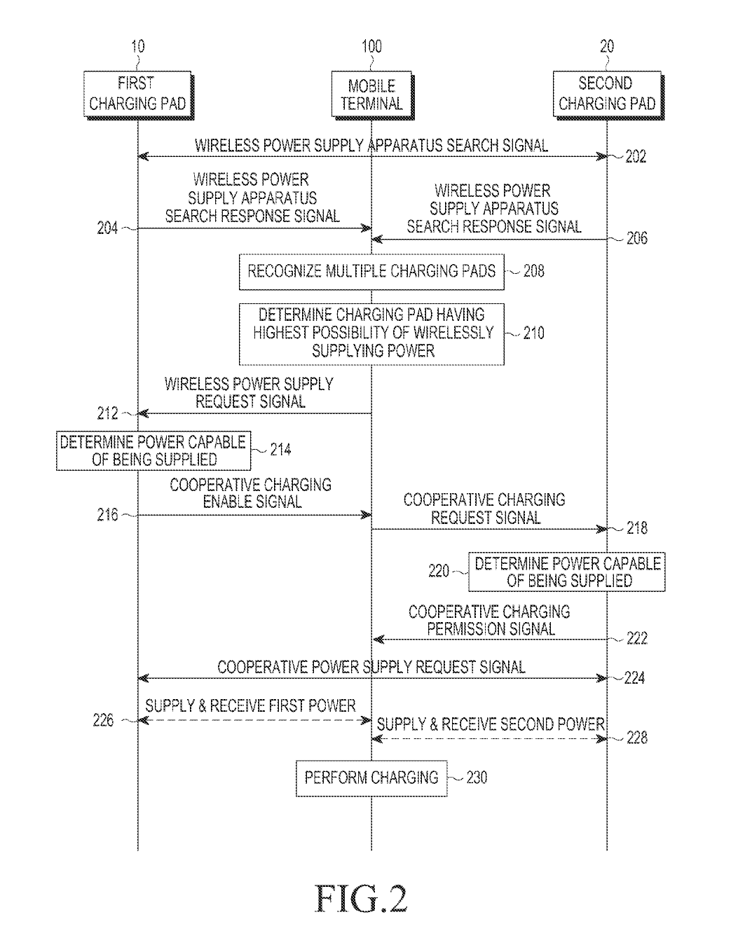

FIG. 2 illustrates a method for performing wireless charging cooperatively between an apparatus for wirelessly receiving power and multiple apparatuses for wirelessly supplying power according to an embodiment of the present invention. In FIG. 2, the apparatus for wirelessly receiving power corresponds to the mobile terminal 100 and the apparatuses for wirelessly supplying power correspond to the first and second charging pads 10 and 20, respectively.

Referring to FIG. 2, in step 202, the mobile terminal 100 transmits a wireless power supply apparatus search signal, in order to receive power from any one of the multiple charging pads.

In step 204 and in step 206, the first and second charging pads 10 and 20, which are close to the mobile terminal 100, receive the wireless power supply apparatus search signals, respectively, and transmit wireless power supply apparatus search response signals to the mobile terminal 100 in response to the received wireless power supply apparatus search signals, respectively.

The mobile terminal 100 receives the wireless power supply apparatus search signal transmitted by each of the first and second charging pads 10 and 20. Accordingly, in step 208, the mobile terminal 100 recognizes the first and second charging pads 10 and 20, which are close to the mobile terminal 100.

Then, in step 210, the mobile terminal 100 determines a charging pad which has the highest possibility of wirelessly supplying power to the mobile terminal 100 among the first charging pad 10 and the second charging pad 20, such as by determining which charging pad is the closest to the mobile terminal 100 or which has the largest received signal strength. It is assumed in FIG. 2 that the first charging pad 10 is the closest to the mobile terminal 100. In step 212, the mobile terminal 100 transmits a wireless power supply request signal to the first charging pad 10 corresponding to the closest charging pad.

In step 214, the first charging pad 10 determines power capable of being supplied, by comparing an amount of power capable of being supplied by itself with an amount of power required for charging of the mobile terminal 100 (i.e. an amount of power requested to be supplied), and determines whether the amount of power capable of being supplied is equal to or greater than the amount of power required for charging. When the amount of power capable of being supplied is less than the amount of power required for charging, the first charging pad 10 determines the power capable of being supplied.

Next, in step 216, the first charging pad 10 transmits a cooperative charging enable signal to the mobile terminal 100. The cooperative charging enable signal may include the amount of power capable of being supplied by the first charging pad 10.

The mobile terminal 100 receives the cooperative charging enable signal, and in step 218, transmits a cooperative charging request signal 218 to the second charging pad 20 having a higher possibility of supplying power to the mobile terminal 100 after the first charging pad 10. In the present invention, it is assumed that the second charging pad 20 closer to the mobile terminal 100 than the first charging pad 10 has a higher possibility of supplying power to the mobile terminal 100 than the first charging pad 10. In this case, in order to satisfy the amount of power required for charging of the mobile terminal 100, the cooperative charging request signal may include information on a required amount of power which must be supplemented with the cooperation of another charging pad except for the power capable of being supplied by the first charging pad 10.

In order to satisfy the amount of power required for charging of the mobile terminal 100, a required amount of power which must be supplemented with the cooperation of another charging pad except for the power capable of being supplied by the first charging pad 10 is referred to herein as an “amount of power requiring cooperation.”

The second charging pad 20 receives the cooperative charging request signal including the amount of power requiring cooperation from the mobile terminal 100, and in step 220, determines an amount of power capable of being supplied. Namely, the second charging pad 20 compares the amount of power that it is capable of supplying with the amount of power requiring cooperation of the mobile terminal 100, and determines whether the amount of power capable of being supplied is equal to or greater than the amount of power requiring cooperation. When the amount of power capable of being supplied is equal to or greater than the amount of power requiring cooperation, the second charging pad 20 transmits a cooperative charging permission signal to the mobile terminal 100 in step 222.

Accordingly, the mobile terminal 100 recognizes that it may perform cooperative charging together with the first and second charging pad 10 and 20. In step 224, the mobile terminal 100 transmits a cooperative power supply request signal 224 to each of the first charging pad 10 and the second charging pad 20, which receive the cooperative power supply request signal from the mobile terminal 100. In step 226, the first charging pad 10 wirelessly transmits power to the mobile terminal 100, which wirelessly receives the power, by using a resonance frequency. In step 228, the second charging pad 20 wirelessly transmits power to the mobile terminal 100, which wirelessly receives the power, by using a resonance frequency.

When the first and second charging pads 10 and 20 wirelessly transmit power to the mobile terminal 100 simultaneously, the mobile terminal 100 may charge as much power as the sum of the powers received from the first charging pad 10 and the second charging pad 20. When the first and second charging pads 10 and 20 wirelessly transmits power to the mobile terminal 100 simultaneously, in order to minimize power transmission loss resulting from power phase difference, it is possible to synchronize phases of first power and second power that the first and second charging pads 10 and 20 simultaneously transmit to the mobile terminal 100.

As the mobile terminal 100 wirelessly receives power from each of the first and second charging pads 10 and 20, it performs charging by using the power received from each of the first and second charging pads 10 and 20, in step 230.

Accordingly, the mobile terminal 100 may receive power from each of the first and second charging pads 10 and 20, which are in the vicinity of the mobile terminal 100, and may perform cooperative wireless charging more efficiently than the existing charging scheme.

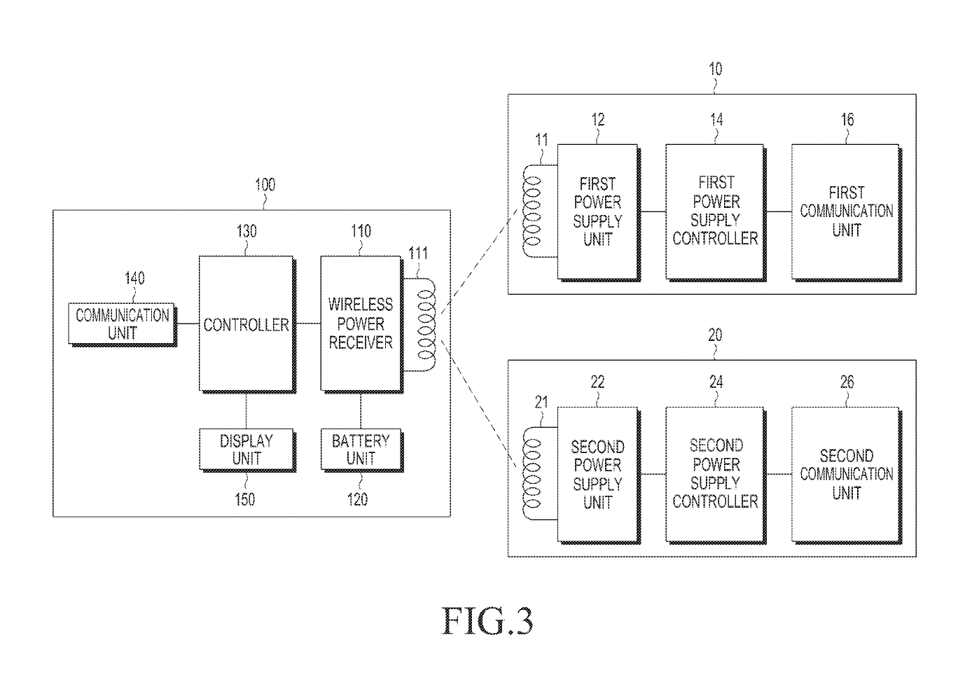

FIG. 3 illustrates the configuration of a mobile terminal 100 and the configuration of first and second charging pads 10 and 20 according to an embodiment of the present invention. Referring to FIG. 3, the mobile terminal 100 may include a power receiver 110, a battery unit 120, a controller 130, a communication unit 140, and a display unit 150.

While the power receiver 110 resonates through a resonance coil 111 at the same frequency as a resonance coil of each of the first and second charging pads 10 and 20, it receives supply power from each of the first and second charging pads 10 and 20, and delivers the received power to the battery unit 120. The power receiver 110 may simultaneously receive supply power from the first and second charging pads 10 and 20. The battery unit 120 charges a battery by using the power received by the power receiver 110. When charging of the battery is completed, the battery unit 120 notifies the completion of charging of the battery to the controller 130.

The controller 130 receives power from each of multiple charging pads (i.e. the first and second charging pads 10 and 20), and controls an overall operation for performing cooperative wireless charging. The controller 130 identifies remaining power of the battery unit 120, and determines whether it is required to receive power (or whether charging is required). When it is required to receive power, the controller 130 controls the communication unit 140 so as to transmit a power supply apparatus search signal, and receives a power supply apparatus search response signal through the communication unit 140. Accordingly, the controller 130 recognizes charging pads (the first charging pad 10 and the second charging pad 20) close to the mobile terminal 100.

Next, through the communication unit 140, the controller 130 sends a request for supplying power to the first charging pad 10 corresponding to a charging pad which has the highest possibility of supplying power to the mobile terminal 100 (e.g., which is the closest to the mobile terminal 100 or which has the largest received signal strength) among the first charging pad 10 and the second charging pad 20 existing around the mobile terminal 100. Also, the controller 130 receives a cooperative charging enable signal from the first charging pad 10 through the communication unit 140. The cooperative charging enable signal may include an amount of power capable of being supplied by the first charging pad 10. When the cooperative charging enable signal has been received, the controller 130 transmits, through the communication unit 140, a cooperative charging request signal 218 to the second charging pad 20 having a higher possibility of supplying power to the mobile terminal 100 than the first charging pad 10.

In the present invention, it is assumed that the second charging pad 20 closer to the mobile terminal 100 than the first charging pad 10 has a higher possibility of supplying power to the mobile terminal 100 than the first charging pad 10. When a cooperative charging permission signal is received from the second charging pad 20, the controller 130 recognizes that the mobile terminal 100 may perform cooperative charging together with the first and second charging pad 10 and 20, and controls the communication unit 140 so as to transmit a cooperative power supply request signal to each of the first charging pad 10 and the second charging pad 20. Then, the controller 130 controls the power receiver (or wireless power receiver) 110 so as to wirelessly receive power from each of the first and second charging pads 10 and 20, and performs a control operation for performing charging by using power received from each of the first and second charging pads 10 and 20.

According to the control of the controller 130, the communication unit 140 communicates with each of the first charging pad 10 and the second charging pad 20, and delivers a signal received from each of the first charging pad 10 and the second charging pad 20, to the controller 130. Then, the communication unit 140 transmits a signal, the transmission of which has been requested by the controller 130, to each of the first charging pad 10 and the second charging pad 20. The communication unit 140 as described above may be implemented in a near field communication scheme, for example, by using an NFC IC (Near Field Communication Integrated Circuit), and may communicate with each of the first charging pad 10 and the second charging pad 20 through an NFC channel.

The display unit 150 may include an LCD (Liquid Crystal Display) or an OLED (Organic Light Emitting Diode) display device, for example. According to the control of the controller 130, the display unit 150 may display the remaining power of a battery, whether charging is required, the existence of the first charging pad 10 and the second charging pad 20 around the mobile terminal 100, a cooperative charging enable signal or a cooperative charging permission signal from the first charging pad 10 or the second charging pad 20, and all states such as a state of searching for an apparatus for supplying power, requesting cooperative charging, or determining power capable of being supplied, until cooperative wireless charging is performed.

According to an embodiment of the present invention, the first charging pads 10 may include the same elements as the second charging pads 20, and may only be discriminated from the second charging pads 20 according to the possibility of supplying power to the mobile terminal 100. In the present invention, the description has been made of when it is assumed that the first charging pad 10 is an apparatus for supplying power which is the closest to the mobile terminal 100, and it is assumed that the second charging pad 20 is closer to the mobile terminal 100 than the first charging pad 10. However, each of the first and second charging pads 10 and 20 may operate as an apparatus for supplying power which is the closest to the mobile terminal 100, or may operate as an apparatus for supplying power which is the next closest after the closest apparatus for supplying power.

In the present invention, because the second charging pad 20 includes the same elements as the first charging pad 10, a description of only one of these charging pads is made, for conciseness. In this case, a first power supply unit 12 is matched with a second power supply unit 22, a first power supply controller 14 is matched with a second power supply controller 24, and a first communication unit 16 is matched with a second communication unit 26.

The first charging pad 10 may include the first power supply unit 12, the first power supply controller 14, and the first communication unit 16.

The first power supply unit 12 resonates through a first resonance coil 11 at the same frequency as the resonance coil 111 of the power receiver 110 in the mobile terminal 100, and transmits supply power to the power receiver 110.

The first power supply controller 14 generally controls an operation for supplying power to the mobile terminal 100, cooperatively with the second charging pad 20. When the first power supply controller 14 receives a wireless power supply apparatus search signal from the mobile terminal 100 through the first communication unit 16, it controls the first communication unit 16 so as to transmit a wireless power supply apparatus search response signal to the mobile terminal 100 in response to the wireless power supply apparatus search signal.

When the first power supply controller 14 receives a power supply request signal from the mobile terminal 100 through the first communication unit 16, it compares an amount of power capable of being supplied by the first charging pad 10 with an amount of power required for charging (i.e. an amount of power requested to be supplied) of the mobile terminal 100. By the comparison, the first power supply controller 14 determines whether the amount of power capable of being supplied is equal to or greater than the amount of power required for charging. When the amount of power capable of being supplied is less than the amount of power required for charging, the first power supply controller 14 controls the first communication unit 16 so as to transmit a cooperative charging enable signal to the mobile terminal 100. The cooperative charging enable signal may include the amount of power capable of being supplied by the first charging pad 10.

When the first power supply controller 14 receives a cooperative charging request signal from the mobile terminal 100 through the first communication unit 16, it compares the amount of power capable of being supplied by the first charging pad 10 with an amount of power requiring cooperation included in the cooperative charging request signal, and determines whether the amount of power capable of being supplied is equal to or greater than the amount of power requiring cooperation. When the amount of power capable of being supplied is equal to or greater than the amount of power requiring cooperation, the first power supply controller 14 controls the first communication unit 16 so as to transmit a cooperative charging permission signal to the mobile terminal 100.

When the first power supply controller 130 receives a cooperative power supply request signal from the mobile terminal 100 in response to the transmission of the cooperative charging permission signal, it controls the first power supply unit 12 so as to wirelessly transmit power to the mobile terminal 100 by using a resonance frequency. Namely, the first power supply controller 14 performs a control operation so that the first charging pad 10, simultaneously with another charging pad, may wirelessly transmit power to the mobile terminal 100. In order to minimize power transmission loss resulting from a difference between a phase of first power transmitted from the first power supply unit 12 to the mobile terminal 100 and a phase of second power transmitted from another charging pad to the mobile terminal 100, the first power supply controller 130 may perform a control operation for synchronizing a phase of the first power with that of the second power.

According to the control of the first power supply controller 14, the first communication unit 16 communicates with the communication unit 140 of the mobile terminal 100, and delivers various signals received from the mobile terminal 100, to the first power supply unit 12. Then, the first communication unit 16 transmits various signals, transmissions of which have been requested by the first power supply controller 14, to the mobile terminal 100. The first communication unit 16 as described above may be implemented in a near field communication scheme, for example, by using an NFC IC, and may communicate with the mobile terminal 100 through an NFC channel.

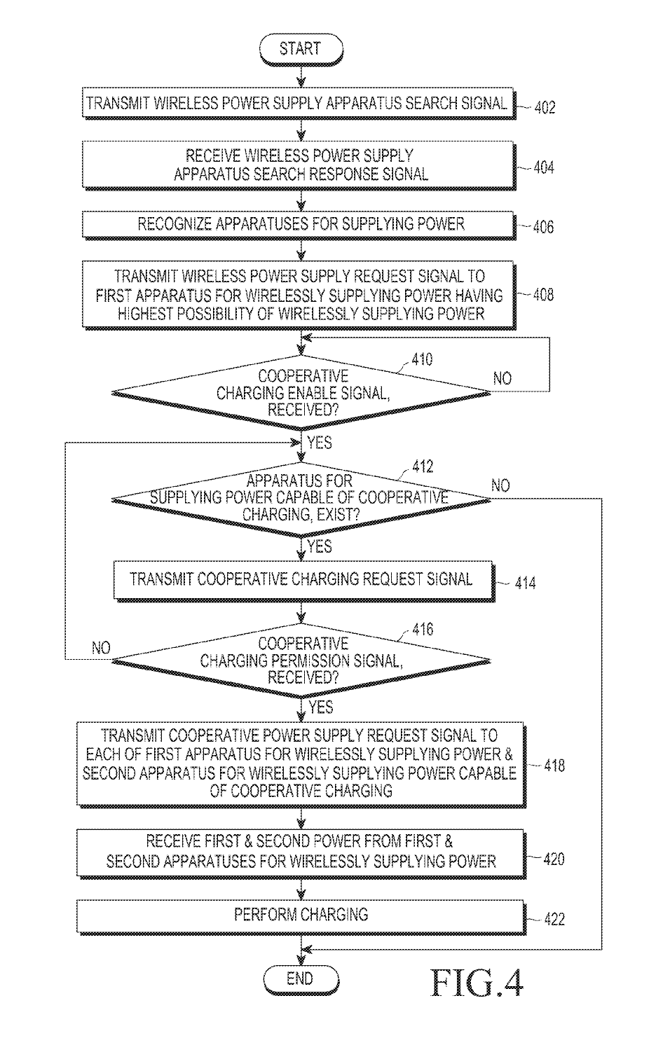

FIG. 4 illustrates the operation of a mobile terminal according to an embodiment of the present invention. Referring to FIG. 4, in step 402, the mobile terminal 100 transmits a power supply apparatus search signal through the communication unit 140 when charging is required.

In step 404, the mobile terminal 100 receives a power supply apparatus search response signal through the communication unit 140. In step 406, by using the received power supply apparatus search signal, the mobile terminal 100 recognizes multiple apparatuses for supplying power, which are in the vicinity of the mobile terminal 100.

Then, in step 408, the mobile terminal 100 determines the first apparatus for supplying power to have the highest possibility of supplying power to the mobile terminal 100 among the multiple apparatuses for supplying power, which are in the vicinity of the mobile terminal 100, and transmits a power supply request signal to the first apparatus for supplying power. For example, the mobile terminal 100 may determine the first apparatus for supplying power to be the closest to the mobile terminal 100 or to have the largest received signal strength. In FIG. 4, it is assumed that the first charging pad 10 is the first apparatus for supplying power which has the highest possibility of supplying power to the mobile terminal 100.

After the mobile terminal 100 transmits the power supply request signal to the first charging pad 10, it determines in step 410 whether a cooperative charging enable signal is received from the first charging pad 10. The cooperative charging enable signal may include an amount of power capable of being supplied by the first charging pad 10 versus an amount of power required for charging requested by the mobile terminal 100.

When the mobile terminal 100 receives the cooperative charging enable signal from the first charging pad 10, it determines in step 412 whether there exists a second (i.e, another) apparatus for supplying power capable of performing cooperative charging. For example, the mobile terminal 100 determines whether there exists another charging pad which has a higher possibility of supplying power to the mobile terminal 100 than the first charging pad 10 among the recognized multiple apparatuses for supplying power. In the present invention, it is assumed that the second charging pad 20 next closest to the mobile terminal 100 than the first charging pad 10 has a higher possibility of supplying power to the mobile terminal 100 than the first charging pad 10.

When there exists the second charging pad 20 capable of performing cooperative charging, the mobile terminal 100 transmits a cooperative charging request signal to the second charging pad 20, in step 414. The cooperative charging request signal may include an amount of power requiring cooperation, which signifies a required amount of power which must be supplemented with the cooperation of another charging pad except for the power capable of being supplied by the first charging pad 10, in order to satisfy the amount of power required for charging of the mobile terminal 100.

After the mobile terminal 100 transmits the cooperative charging request signal to the second charging pad 20, it determines in step 416 whether a cooperative charging permission signal is received. For example, the mobile terminal 100 determines whether the cooperative charging permission signal is received from the second charging pad 20.

When the cooperative charging permission signal is received from the second charging pad 20, the mobile terminal 100 transmits, in step 418, a power supply request signal to each of the first charging pad 10 corresponding to the first apparatus for supplying power and the second charging pad 20 corresponding to the second apparatus for supplying power.

Then, in step 420, the mobile terminal 100 receives first power from the first charging pad 10 and receives second power from the second charging pad 20. In step 422, the mobile terminal 100 performs charging by using the received first power and second power.

When a power supply request signal is received from the mobile terminal 100, the apparatus for wirelessly supplying power according to the present invention may operate as the first charging pad. Otherwise, when a cooperative charging request signal is received from the mobile terminal 100, the apparatus for wirelessly supplying power according to the present invention may operate as the second charging pad 20.

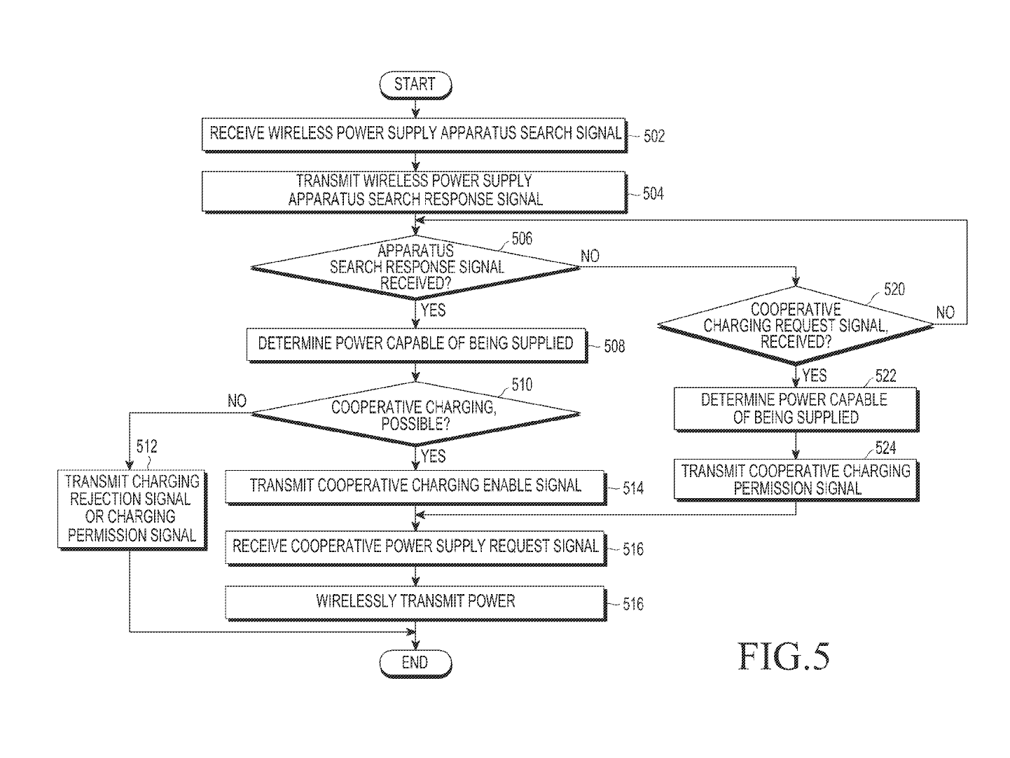

FIG. 5 illustrates the operation of an apparatus for wirelessly supplying power according to an embodiment of the present invention. Referring to FIG. 5, when the apparatus for wirelessly supplying power receives a wireless power supply apparatus search signal from the mobile terminal 100 in step 502, it proceeds to step 504 in which the apparatus for wirelessly supplying power transmits a wireless power supply apparatus search response signal to the mobile terminal 100.

Accordingly, in step 506, the apparatus for wirelessly supplying power determines whether a charging request signal (i.e. a wireless power supply request signal) is received from the mobile terminal 100.

When the wireless power supply request signal is received, the apparatus for wirelessly supplying power determines an amount of power that is is capable of supplying, in step 508. Then, in step 510, the apparatus for wirelessly supplying power determines whether it may perform cooperative charging together with another apparatus for wirelessly supplying power and the mobile terminal 100. At this time, the apparatus for wirelessly supplying power compares an amount of power that is is capable of supplying with an amount of power required for charging of the mobile terminal 100. When the amount of power that is is capable of supplying is equal to or greater than the amount of power required for charging, or when there is no amount of power capable of being supplied, the apparatus for wirelessly supplying power determines that the cooperative charging may not be performed.

The apparatus for wirelessly supplying power compares the amount of power that is capable of supplying with the amount of power required for charging of the mobile terminal 100, and determines that the cooperative charging may be performed, when the amount of power that is is capable of supplying is less than the amount of power required for charging, or when there exists the amount of power capable of being supplied.

When the cooperative charging may be performed, the apparatus for wirelessly supplying power transmits a cooperative charging enable signal to the mobile terminal 100, in step 514. The cooperative charging enable signal may include the amount of power capable of being supplied by the apparatus for wirelessly supplying power.

In response to a cooperative charging permission signal transmitted from the apparatus for wirelessly supplying power to the mobile terminal 100, the apparatus for wirelessly supplying power receives a cooperative power supply request signal from the mobile terminal 100, in step 516. In step 518, the apparatus for wirelessly supplying power wirelessly transmits as much power as it is capable of supplying, to the mobile terminal 100.

When the wireless power supply request signal is not received from the mobile terminal 100, the apparatus for wirelessly supplying power determines in step 520 whether a cooperative charging request signal is received from the mobile terminal 100. When the cooperative charging request signal is received from the mobile terminal 100, the apparatus for wirelessly supplying power determines power that it is capable of supplying, in step 522. The cooperative charging request signal may include an amount of power requiring cooperation, which signifies a required amount of power that the mobile terminal 100 must complementarily receive except for power provided by another apparatus for wirelessly supplying power, in order to satisfy the amount of power required for charging of the mobile terminal 100. Then, the apparatus for wirelessly supplying power compares the amount of power that it is capable of supplying with the amount of power requiring cooperation included in the cooperative charging request signal, and determines whether the amount of power that it is capable of supplying is equal to or greater than the amount of power requiring cooperation.

When a result of the determination in step 522 shows that the amount of power capable of being supplied is equal to or greater than the amount of power requiring cooperation, the apparatus for wirelessly supplying power transmits a cooperative charging permission signal to the mobile terminal 100, in step 524.

In response to the cooperative charging permission signal transmitted as described above, the apparatus for wirelessly supplying power receives a cooperative power supply request signal from the mobile terminal 100, in step 516. In step 518, the apparatus for wirelessly supplying power wirelessly transmits as much power as it is capable of supplying, to the mobile terminal 100.

According to the operation of the apparatus for wirelessly supplying power as described above, the mobile terminal 100 sends a request for cooperative power supply, to the multiple apparatuses for wirelessly supplying power (e.g. the first charging pad 10 and the second charging pad 20), and receives power from each of the multiple apparatuses for wirelessly supplying power. Accordingly, the mobile terminal 100 may perform cooperative wireless charging.

According to the present invention, when the multiple apparatuses for wirelessly supplying power are close to the apparatus for wirelessly receiving power, and when the apparatus for wirelessly receiving power fails to receive sufficient power from the closest first apparatus for wirelessly supplying power, the apparatus for wirelessly receiving power may cooperatively receive power from a second apparatus for wirelessly supplying power, and may perform wireless charging. Therefore, the apparatus for wirelessly receiving power can perform efficient wireless charging.

Although the embodiments have been described in the description of the present invention as described above, various changes and modifications can be made in the embodiments without departing from the scope of the present invention. An example has been described in which the apparatus for wirelessly receiving power corresponds to the mobile terminal and the apparatuses for wirelessly supplying power correspond to the first and second charging pads. However, the apparatus for wirelessly receiving power can be applied to any apparatus which wirelessly receives power, and the apparatus for wirelessly supplying power can be applied to any apparatus which wirelessly provides power. Also, an example has been described in which the number of the multiple apparatuses for wirelessly supplying power is 2, the technical idea of the present invention can be applied to when there are more than two apparatuses for wirelessly supplying power. Therefore, the spirit and scope of the present invention is not limited to the described embodiments thereof, but is defined by the appended claims and equivalents thereof.

What is claimed is:

1. A method for wireless charging in an apparatus that wirelessly receives power, the method comprising:
transmitting, by the apparatus, a wireless power supply apparatus search signal;
receiving a wireless power supply apparatus search response signal;
recognizing multiple apparatuses for wirelessly supplying power, based on the wireless power supply apparatus search response signal;
sending a request for wirelessly supplying power, to a first apparatus for wirelessly supplying power among the multiple apparatuses;
receiving a cooperative charging enable signal from the first apparatus;
sending a request for cooperative charging to a second apparatus for wirelessly supplying power, based on the cooperative charging enable signal from the first apparatus;
receiving a cooperative charging permission signal from the second apparatus;
receiving first power and second power from the first apparatus and the second apparatus, respectively; and
performing wireless charging using the first power and the second power.

2. The method of claim 1, wherein the first apparatus has a highest possibility of supplying power to the apparatus for wirelessly receiving power among the multiple apparatuses.

3. The method of claim 2, wherein the first apparatus is closest in distance to the apparatus for wirelessly receiving power, among the multiple apparatuses.

4. An apparatus for wirelessly receiving power, the apparatus comprising:
a communication unit for communicating with at least one apparatus that wirelessly supplies power;
a power receiver for wirelessly receiving power from multiple apparatuses that wirelessly supply power; and
a controller for controlling the communication unit to transmit a wireless power supply apparatus search signal, recognizing the multiple apparatuses that wirelessly supply power based on a wireless power supply apparatus search response signal received through the communication unit, sending a request for wirelessly supplying power to a first apparatus that wirelessly supplies power among the multiple apparatuses, controlling the communication unit to transmit a cooperative charging request signal to a second apparatus that wirelessly supplies power based on a cooperative charging enable signal received from the first apparatus, and controlling the power receiver to receive first power and second power from the first apparatus and the second apparatus, respectively, when a cooperative charging permission signal is received from the second apparatus.

5. The apparatus of claim 4, further comprising a battery unit for charging using the first power and the second power.

6. The apparatus of claim 4, wherein the first apparatus has a highest possibility of supplying power to the apparatus for wirelessly receiving power among the multiple apparatuses.

7. The apparatus of claim 6, wherein the first apparatus is closest in distance to the apparatus for wirelessly receiving power, among the multiple apparatuses.

8. A method for wireless charging by an apparatus that wirelessly supplies power, the method comprising:
receiving, by the apparatus, a wireless power supply apparatus search signal from an charging apparatus that wirelessly receives power;
transmitting a wireless power supply apparatus search response signal to the charging apparatus;
receiving a power supply request signal including an amount of power required by the charging apparatus;
determining whether an amount of power capable of being supplied by the apparatus is at least equal to the amount of power required by the charging apparatus; and
transmitting a cooperative charging enable signal, when the amount of power capable of being supplied is not at least equal to the amount of power required by the charging apparatus.

9. The method of claim 8, further comprising:
receiving a cooperative power supply request signal from the charging apparatus; and
wirelessly transmitting power to the charging apparatus.

10. A method for wireless charging by an apparatus that wirelessly supplies power, the method comprising:
receiving a cooperative charging request signal including an amount of power requiring cooperation from a charging apparatus that wirelessly receives power;
determining whether an amount of power capable of being supplied by that apparatus is at least equal to the amount of power requiring the cooperation; and
transmitting a cooperative charging permission signal to the charging apparatus, when the amount of power capable of being supplied is at least equal to the amount of power requiring the cooperation.

11. The method of claim 10, further comprising:
receiving a cooperative power supply request signal from the charging apparatus; and
wirelessly transmitting power to the charging apparatus.

12. An apparatus that wirelessly supplies power to a charging apparatus that wirelessly receives power, the apparatus comprising:
a communication unit for communicating with the charging apparatus;
a power supply unit for wirelessly transmitting power; and
a controller for receiving a wireless power supply apparatus search signal from the charging apparatus through the communication unit, controlling the communication unit to transmit a wireless power supply apparatus search response signal, determining whether an amount of power capable of being supplied by the apparatus is at least equal to an amount of power required by the charging apparatus in response to a power supply request signal received from the charging apparatus, and transmitting a cooperative charging enable signal through the communication unit, when the amount of power capable of being supplied by the apparatus is not at least equal to the amount of power required by the charging apparatus.

13. The apparatus of claim 12, wherein the power supply controller determines whether the amount of power capable of being supplied by the apparatus is at least equal to an amount of power requiring cooperation in response to a cooperative charging request signal including the amount of power requiring the cooperation received from the charging apparatus, and transmits a cooperative charging permission signal through the communication unit, when the amount of power capable of being supplied by the apparatus is at least equal to the amount of power requiring the cooperation.
